(19) United States
(12) Patent Application Publication
(10) Pub. No.: US 2003/0095596 A1
(43) Pub. Date: May 22, 2003

(54) IMAGE PROCESSING APPARATUS, IMAGE PROCESSING METHOD, AND A COMPUTER-READABLE STORAGE MEDIUM CONTAINING A COMPUTER PROGRAM FOR IMAGE PROCESSING RECORDED THEREON

(76) Inventor: SEIYA SHIMIZU, KANAGAWA (JP)

Correspondence Address: STAAS & HALSEY LLP, 700 11TH STREET, NW, SUITE 500, WASHINGTON, DC, 20001, US

(21) Appl. No.: 09/294,342

(22) Filed: Apr. 20, 1999

(30) Foreign Application Priority Data
Sep. 14, 1998 (JP) 10-260413

(51) Int. Cl. H04N 7/12

(52) U.S. Cl. 375/240.08; 382/164

(57) ABSTRACT

An image processing apparatus in which a cell-moving picture compressing section extracts all color boundaries each consisting of continuous pixels each having the same color and having a color different from that of the adjacent pixel in a specified direction according to image data for each cell picture used for constructing moving pictures, generates a compressed cell-moving picture file including a group of data using a chain code indicating the extracted color boundary as compressed data for the each cell picture, and also generates a compressed cell-moving picture file including information for specifying a frame to be used for each compressed data.

### FIELD OF THE INVENTION

The present invention relates to an apparatus and a method for image processing and more particularly, to an apparatus for and a method of preparing less-redundant data representing an image having a comparatively clear color boundary like, for instance, a cell picture; an apparatus for and a method of restoring original image from the data; as well as to a computer-readable storage medium containing a computer program for image processing recorded thereon.

### BACKGROUND OF THE INVENTION

There have been known various types of method for compressing image data for the purpose of storage and transmission. For instance, as a compression method for a color still picture, there has been known JPEG (Joint Photographic coding Experts Group) recommended by International Telecommunication Union (ITU) and International Standards Organization (ISO) as an international standard. As a compression method for color moving-picture communications, there has been known MPEG (Moving Picture Experts Group) recommended by ISO as an international standard, and standardization of three types of compression method referred to as MPEG1, MPEG2, and MPEG4 are being fostered.

Although these methods can not completely restore the original image (irreversible compression method), there has been known a method such as a run-length coding method as a reversible compression method enabling complete restoration of the original image. Disclosed in Japanese Patent Laid-Open Publication No. SHO 61-274473 is a technology classified in the reversible compression method in which, when an image to be compressed is divided into areas each with pixels in the same color, data consisting of outline information indicating outline and colors of each of the area is decided as compressed data.

Of the existing methods as described above, the irreversible compression method can not be used for images which require complete restoration, and so the reversible compression method is used. For instance, there are pictures referred to as moving pictures or cell moving pictures obtained by combining a cell picture with a background picture to prepare each frame as schematically shown in FIG. 20, but when the moving pictures are compressed, it is desired to compress at least a section relating to the cell picture using the reversible compression method so as to enable color edits of a cell picture and enable reproduction of a picture with clear boundaries.

When the run-length compression is performed to a cell picture section, however, a high compression ratio can not be obtained. In accordance with the technology described in Japanese Patent Laid-Open Publication No. SHO 61-274473, although a comparatively high compression ratio can be achieved complicated processing such as outline extraction has to be carried out at the time of compression. Further, the processing of decompression also requires, after an outline thereof is decompressed, a complicated work such that inside and outside of the area are determined. Namely, the technology according to the Publication requires much time to decompress the data, which indicates a technology having difficulty in continuous decompression (high-speed reproduction of moving pictures) in a short cycle.

### SUMMARY OF THE INVENTION

It is an object of the present invention to provide an image processing apparatus for and an image processing method of enabling generation of compressed data which can completely be decompressed, and an image processing apparatus for and an image processing method of enabling restoration of the original image from the compressed data.

The image processing apparatus according to the first aspect of the present invention comprises a pixel retrieving unit for retrieving all pixels each having a color different from that of the adjacent pixel in a specified direction among pixels constituting an image; a color boundary retrieving unit for retrieving all color boundaries each as a group of continuous pixels having the same color among the pixels retrieved by the pixel retrieving unit; a color boundary data generating unit for generating color boundary data, for each of the color boundaries retrieved by the color boundary retrieving unit, including chain code data indicating a position as well as a form of each color boundary and information indicating a color that pixels constituting the color boundary commonly have; and an output unit for outputting data including all the color boundary data generated by the color boundary data generating unit as compressed image data concerning the image.

Namely, the image processing apparatus as the first aspect of the present invention extracts all color boundaries each consisting of continuous pixels each having the same color and having a color different from that of the adjacent pixel in a specified direction from an original image, and outputs a group of data using a chain code indicating the extracted color boundary as compressed data. An output unit as one of components of the image processing apparatus according to the first aspect may be any unit for outputting compressed image data to a storage device such as a hard disk drive, and also may be any unit for outputting compressed image data to a communication line.

Compressed image data outputted from the image processing apparatus according to this first aspect can completely be decompressed to its original image by an image processing apparatus according to the second aspect of the present invention comprising a color boundary diagram generating unit for generating, according to compressed image data including a plurality of color boundary data each representing a color boundary with continuous pixels having the same color and comprising chain code data and information indicating colors, a color boundary diagram as an image having a plurality of color boundaries represented by the plurality of color boundary data; and a decompressed image generating unit for generating a decompressed image as an image obtained by allocating, to each of pixels not constituting any color boundary within the color boundary diagram generated by the color boundary diagram generating unit, the same color as that of a pixel positioned in a specified direction to the pixel and constituting the closest color boundary thereto.

In other words, the compressed image data outputted from the image processing apparatus according to the first aspect thereof can completely be decompressed to its original image with easy processing (accordingly, quickly). For this reason, with the image processing apparatus according to the second aspect of the present invention, the original image can be restored without giving any influence over other processing. Also a plurality of compressed image data can continuously be decompressed in a short cycle.

For realizing the image processing apparatus according to the first aspect of the present invention, as a pixel retrieving unit, a unit for retrieving all pixels each having a color different from that of the adjacent pixel in a specified direction among pixels in an area of an image with all the pixels existing outside of the area having a particular color can be employed, and as an output unit, a unit for outputting data also including area information indicating a position and a form of the area where the pixel retrieving unit has retrieved pixels as compressed image data concerning the image can be employed.

Compressed image data outputted from the image processing apparatus according to the first aspect thereof in which those units described above are employed can completely be decompressed by the image processing apparatus according to the second aspect thereof of the present invention in which a unit for generating, according to the compressed image data, a color boundary diagram as an image having a plurality of color boundaries indicated by a plurality of color boundary data in an area indicated by the area information with all pixels existing outside of the area having a particular color can be employed as a color boundary diagram generating unit.

Namely, the compressed image data outputted from the image processing apparatus according to the first aspect thereof comprising the retrieving unit described above can more quickly be decompressed to its original image. For this reason, with the image processing apparatus according to the second aspect thereof having the color boundary diagram generating unit described above, the original image can be restored without giving any influence over other processing. Also a plurality of compressed image data can continuously be decompressed in a short cycle.

For realizing the image processing apparatus according to the first aspect of the present invention, the apparatus can also additionally provide therein a compressed moving-picture data outputting unit for outputting compressed moving-picture data including a plurality of compressed image data in a form showing an order of using the compressed image data outputted by the output unit as a result that each of the plurality of images is processed by the pixel retrieving unit respectively. Namely, the image processing apparatus according to the first aspect thereof can also be modified so as to output compressed moving-picture data representing moving pictures.

It should be noted that decompression of compressed moving-picture data outputted from the image processing apparatus according to the first aspect thereof having the compressed moving-picture data outputting unit is realized by using the image processing apparatus according to the second aspect of the present invention additionally providing therein a compressed moving-picture data processing unit as a unit functioning according to compressed moving-picture data including a plurality of compressed image data in a form showing the order of using the data and for making a color boundary diagram generating unit process each compressed image data included in the compressed moving-picture data according to the order of using the data.

For realizing the image processing apparatus according to the first aspect of the present invention, the apparatus can also additionally provide therein a compressed moving-picture data outputting unit for outputting compressed moving-picture data including a plurality of compressed image data outputted by the output unit as a result that each of the plurality of images is processed by the pixel retrieving unit, and also compressed moving-picture data including data correlating each of the compressed image data to an order of using each data in a format in which the identical compressed image data can be arranged according to different orders of use.

With the image processing apparatus according to the first aspect thereof configured as described above, the compressed moving-picture data for moving pictures in which an identical image may be used in a plurality of frames can be controlled so as to include only one compressed image data concerning the image. Accordingly, compression of image information can be realized with a high compression ratio.

It should be noted that compressed moving-picture data outputted from the image processing apparatus according to the first aspect thereof having this compressed moving-picture data outputting unit can be decompressed by the image processing apparatus according to the second aspect of the present invention additionally providing therein a compressed moving-picture data processing unit as a unit functioning according to a plurality of compressed image data as well as to compressed moving-picture data including data correlating each of the compressed image data to an order of using each data in a format in which the identical compressed image data can be arranged according to different orders of use for making the color boundary diagram generating unit process each compressed image data included in the compressed moving-picture data according to the order of using the data.

For realizing the image processing apparatus according to the first aspect of the present invention, the apparatus additionally provides therein a table information preparing unit for preparing table information for correlating index values different to each other to all types of colors that pixels constituting the image have, and may employ a unit as a color boundary data generating unit for generating color boundary data including an index value correlated to each color by the table information as information representing colors, and also employ a unit as a compressed image data outputting unit for outputting data including all the color boundary data generated by the color boundary data generating unit as well as the table information as compressed image data concerning the image.

With the image processing apparatus according to the first aspect thereof configured as described above, an image having a small number of used colors can be compressed with a high compression ratio.

Decompression of compressed image data outputted from the image processing apparatus according to the first aspect thereof having the table information preparing unit is realized by using the image processing apparatus according to the second aspect of the present invention additionally employing a unit as a decompressed image generating unit for generating an image by allocating, to each of pixels not constituting any color boundary within the color boundary diagram generated by the color boundary diagram generating unit, the same index value as that of a pixel positioned in a specified direction to the pixel and constituting the closest color boundary thereto, and generating a decompressed image as an image obtained by allocating a color correlated to an index value of each pixel constituting the image thereto with the table information, or by using an image processing apparatus further additionally providing therein a rewriting unit for rewriting contents of table information included in the compressed image data according to the inputted information. With the image processing apparatus according to the second aspect thereof with the rewriting unit further additionally provided therein, color edits to the compressed image data can be performed.

Further the image processing apparatus according to the first aspect of the present invention may be realized by additionally providing thereto a compressed background image data generating unit for decompressing image data for a background image used as a background of the image in which pixels are retrieved by a pixel retrieving unit in a specified compression method and generating compressed background image data.

Decompression of compressed background image data as well as compressed image data outputted from the image processing apparatus according to the first aspect thereof with the compressed background image data generating unit additionally provided therein is realized by using the image processing apparatus according to the second aspect thereof additionally providing therein a background image generating unit for decompressing compressed background image data and generating a background image and a superimposing unit for generating an image with a decompressed image generated by the decompressed image generating unit superimposed on a background image generated in this background image generating unit.

Other objects and features of this invention will become apparent from the following description with reference to the accompanying drawings.

### BRIEF DESCRIPTION OF THE DRAWINGS

FIG. 1 is a functional block diagram of an image processing apparatus according to one embodiment of the present invention;

FIG. 2 is a detailed functional block diagram of a cell-moving picture compressing section provided in the image processing apparatus according to this embodiment;

FIG. 3 is a schematic view explaining the operation of the image processing apparatus according to this embodiment;

FIGS. 4A and 4B are explanatory views of a chain code included in color boundary data generated by the image processing apparatus according to this embodiment;

FIG. 5 is a schematic view explaining the operation of the cell-moving picture compressing section provided in the image processing apparatus according to this embodiment;

FIG. 6 is a schematic view explaining the operation of the cell-moving picture compressing section provided in the image processing apparatus according to this embodiment;

FIG. 7 is a detailed functional block diagram of the cell-moving picture decompressing section provided in the image processing apparatus according to this embodiment;

FIG. 8 is a schematic view explaining the operation of the cell-moving picture decompressing section provided in the image processing apparatus according to this embodiment;

FIG. 9 is a block diagram showing hardware configuration of the image processing apparatus according to this embodiment;

FIG. 10 is a flow chart of compression processing executed in the image processing apparatus according to this embodiment;

FIG. 11 is a view showing configuration of the compressed cell-moving picture file generated by the image processing apparatus according to this embodiment;

FIG. 12 is a flow chart of frame encoding processing executed in the image processing apparatus according to this embodiment;

FIG. 13 is an explanatory view of a circumscribed rectangular area decided at the time of compression in the image processing apparatus according to this embodiment;

FIGS. 14A and 14B are explanatory views of color boundary diagram data generated at the time of compression in the image processing apparatus according to this embodiment;

FIG. 15 is a flow chart of decompression processing executed in the image processing apparatus according to this embodiment;

FIG. 16 is a flowchart of decompressing processing of frame data executed in the image processing apparatus according to this embodiment;

FIG. 17 is a flow chart of decompressing processing of a cell picture executed in the image processing apparatus according to this embodiment;

FIGS. 18A and 18B are explanatory views of decompressing processing of a cell picture executed in the image processing apparatus according to this embodiment;

FIG. 19 is a schematic view for explaining a method of realizing the image processing apparatus according to this embodiment; and

FIG. 20 is an explanatory view showing a moving picture prepared by combining a cell picture and a background picture.

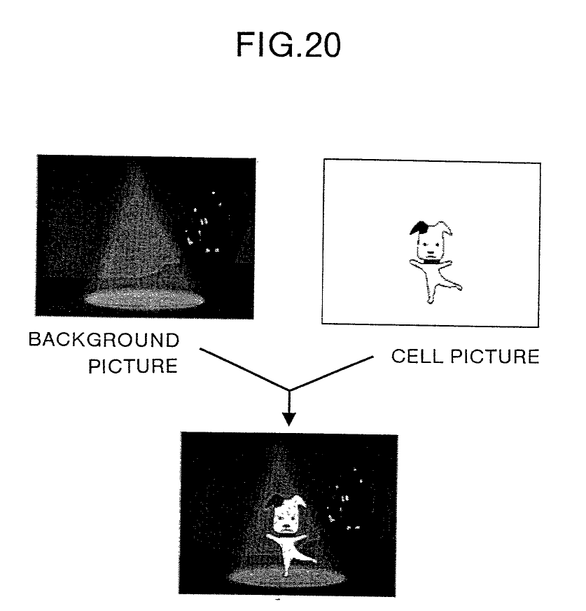

### DESCRIPTION OF THE PREFERRED EMBODIMENTS

Detailed description is made for the preferred embodiments of the image processing apparatus and image processing method according to the present invention with reference to the related drawings.

The image processing apparatus according to one embodiment of the present invention is an apparatus for generating compressed data (with less redundancy) indicating moving pictures prepared by combining cell pictures with background pictures, and generating image data for a plurality of frames consisting of the moving pictures by decompressing the data. This image processing apparatus is also an apparatus for generating data with which color edits of cell picture sections in the moving pictures is performed in a state where the data is being compressed as it is.

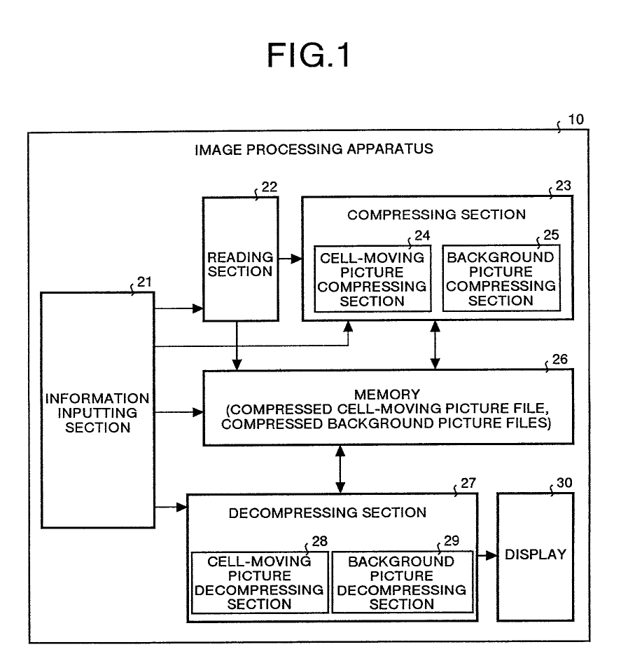

At first, description is made for configuration of the image processing apparatus according to one embodiment of the present invention with reference to a functional block diagram shown in FIG. 1. As shown in the figure, the image processing apparatus 10 according to the embodiment functions as an apparatus comprising a information inputting section 21, a reading section 22, a compressing section 23, a memory 26, a decompressing section 27, and a display 30.

The information inputting section 21 is an interface for obtaining various information from an operator. The information inputting section 21 interprets meanings of inputted information according to a situation at that point of time. The information inputting section 21 provides the information itself or information according to the information to a section corresponding to a result of interpretation. The memory 26 stores therein filed data. The display 30 has a function of receiving image data consisting of color information (described as color-information image data hereinafter) with a specified bit length (a 32-bit length in this embodiment), and displaying an image corresponding to the image data on a screen.

The reading section 22 has a function of reading a picture drawn on paper and generating color-information image data representing the picture. The reading section 22 operates singly or in association with the compressing section 23 according to the information (instruction) given from the information inputting section 21. Namely, the apparatus is programmed to prepare all the color-information image data of each original picture (cell picture, background picture), and then enable both preparation of compressed data for moving pictures using those original pictures and preparation of compressed data while each original picture is read in. The reading section 22 operates singly when the apparatus is used in the former configuration, and operates in association with the compressing section 23 when the apparatus is used in the latter configuration.

The compressing section 23 prepares one compressed cell-moving picture file and more than one compressed background picture files in the memory 26 according to color-information image data for a plurality sheets of cell picture and more than one sheet of background pictures for preparing moving pictures. Herein, the compressed cell-moving picture file is a file of compressed data indicating a plurality framefuls of color-information image data corresponding to moving pictures (described as cell-moving pictures hereinafter) prepared without any background picture, while the compressed background picture file is a file of compressed data indicating color-information image data for background pictures. It should be noted that the compressed cell-moving picture file and compressed background picture file are prepared by a cell-moving picture compressing section 24 and a background picture compressing section 25 in the compressing section 23.

The decompressing section 27 comprises a cell-moving picture decompressing section 28 for decompressing a plurality of color-information image data constituting cell-moving pictures according to data in the compressed cell-moving picture file, and a background picture decompressing section 29 for decompressing color-information image data for background pictures according to data in the compressed background picture files. The cell-moving picture decompressing section 28 and background picture decompressing section 29 operate in association with each other, successively generate, when information for instructing reproduction of moving pictures is given from the information inputting section 21, image data in each frame comprising moving pictures, and supply the image data to the display 30.

When information for instructing execution of color edits is given from the information inputting section 21 the cell-moving picture decompressing section 28 and background picture decompressing section 29 generate one specified frame of color-information image data for moving pictures, and supply the data to the display 30. Then, the cell-moving picture decompressing section 28 updates contents of the compressed cell-moving picture file so that a section drawn with a certain color of a cell picture displayed on the screen of the display 30 is changed to that with a different color.

Detailed description is made hereinafter for the operation of the image processing apparatus 10 according to the embodiment. At first detailed description is made for a sequence of preparing compressed data by the image processing apparatus 10 assuming the case that moving pictures as an object use a plurality sheets of background pictures and a plurality sheets of cell pictures, and that a file of color-information image data for each background picture (described as a background picture file hereinafter) and a file of color-information image data for each cell picture (described as a cell picture file hereinafter) are already prepared in the memory 26.

In this case, the operator inputs file IDs of all background picture files to be used into the information inputting section 21 and also inputs information for specifying more than one frame, for each file ID, in which color-information image data in a file identified with the file ID is used. The operator also inputs information concerning cell pictures. Further, the operator inputs information “FRAMENUM” for a total frame number indicating a total number of frames constituting moving pictures, information “FRAMERATE” for a reproduction rate indicating a number of frames to be reproduced per second, information “WIDTH”, “HEIGHT” indicating an image size, and a title of moving pictures (described as moving-picture name hereinafter) or the like.

When the input of a series of information described above is completed, the information inputting section 21 provides each file ID of the background picture files obtained from the operator to the background picture compressing section 25. The information inputting section 21 also provides the information of “WIDTH”, “HEIGHT”, “FRAMENUM”, and “FRAMERATE” (those information is described as control information hereinafter) obtained from the operator as well as time chart information including a file ID list as a list with file IDs for cell picture files arranged in the order of using them to the cell-moving picture compressing section 24.

The information inputting section 21 prepares a background-picture managing file, in the memory 26, as a file capable of being identified by using a moving-picture name, and including control information, file IDs (obtained by changing a file-ID extension of a background picture file) of a compressed background files prepared from each background picture file, and information for specifying some frames with data in a file identified by each file ID to be used therein.

The background-picture compressing section 25 having received a file ID reads a file having the file ID from the memory 26 and compresses the file. It should be noted that the background picture compressing section 25 employs an image compressing system by JPEG. Then, the background picture compressing section 25 prepares a compressed background picture file with the compressed result stored therein in the memory 26. In this case, the background picture compressing section 25 uses a file ID (obtained by changing the extension), as a file ID for a compressed background picture file, identified from the file IDs for the original background picture files.

Namely, concerning background pictures, compressed background picture files for the background picture files specified by the operator, file IDs for those compressed background pictures, background picture managing files with information indicating the order of using them stored therein are prepared in the memory 26.

Next description is made for an operation of the cell-moving picture compressing section 24 with time chart information provided thereto.

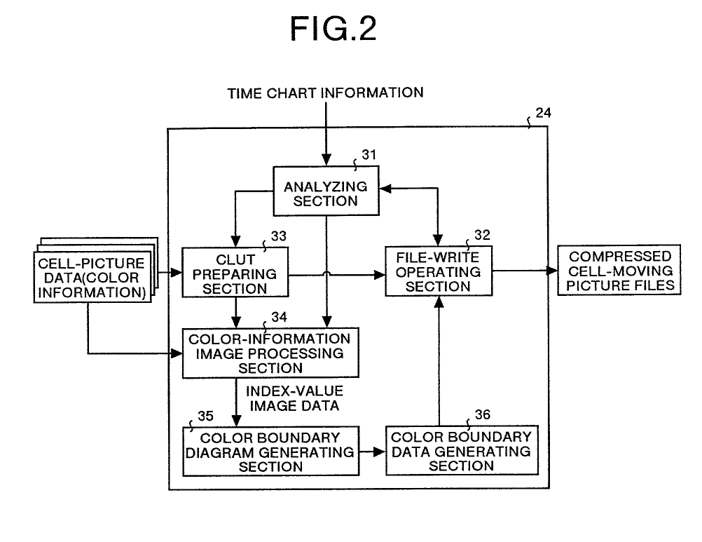

When the cell picture files required for processing exist in the memory 26, as shown in FIG. 2, the cell-moving picture compressing section 24 operates as a section comprising an analyzing section 31, a file-write operating section 32, a color lookup table preparing section (CLUT preparing section) 33, a color-information image processing section 34, a color boundary diagram generating section 35, a color boundary data generating section 36. The cell-moving picture compressing section 24 starts its operation when the analyzing section 31 receives time chart information from the information inputting section 21.

As already described, the time chart information includes the control information and file ID list. When the time chart information described above is provided, the analyzing section 31 provides the control information to the file-write operating section 32, and also provides each file ID included in the file ID list without overlap among them (ignore some of the files that overlap) to the CLUT preparing section 33.

The file-write operating section 32 with the control information provided thereto prepares a file of the control information (a file as a compressed cell-moving picture file) Then, the file-write operating section 32 adds a frame-start address table as a table capable of storing therein start addresses (address information for specifying a position of data in the compressed cell-moving picture file) in number indicated by a total frame number information included in the control information to the end of the file.

While the CLUT preparing section 33 with file IDs provided thereto prepares, by accessing the files each having a file ID, a color lookup table as a table with all types of color information included in color-information image data for a series of cell pictures used for structure of moving pictures correlated to index values. More specifically, the CLUT preparing section 33 prepares, at first, a table capable of storing therein 256-color information with color information (&H00000000) for background colors as first color information (color information correlated to the index value “0” (&H00)) stored therein.

Then, the CLUT preparing section 33 compares each color information included in each color-information image data to color information registered in the table, registers (stores), when there is no same color information therein, the color information in an area of the table where the color information is not registered. When processing to all the specified files is completed the CLUT preparing section 33 provides the table with each of the color information registered therein (namely, the color lookup table) to the file-write operating section 32.

The file-write operating section 32 receiving the color lookup table writes the color lookup table in the end of the compressed cell-moving picture file at that point of time, namely immediately behind the frame-start address table. Then the number “1” is set in a processing-object frame number as information used for determining a frame as a processing object (a frame to which next information given from the color boundary data generating section 36 or analyzing section targets).

After supplying the file ID to the CLUT preparing section 33, the analyzing section 31 performs processing for supplying the file IDs included in the file ID list in the order of the header file ID thereof to the color-information image processing section 34 by referring to a cell-picture managing table stored therein. The cell-picture managing table is a table for storing therein a correlation between file IDs and start addresses, and when processing to some moving pictures is started, the analyzing section 31 prepares an empty cell-picture managing table.

Following the preparation of the cell-picture managing table, the analyzing section 31 successively selects file IDs in the file ID list as processing objects and provides, when a file ID selected as a processing object is not stored in the cell-picture managing table, the file ID to the color-information image processing section 34. Then, a set of the file ID and start address is registered in the cell-picture managing table.

It should be noted that the analyzing section 31 uses, when the set thereof is first registered, an address next to an end position of the area with the color lookup table stored therein as a start address, and uses, when the set is registered after the second time and on, the start address (details are described later) reported by the file-write operating section 32 as a result of supplying the registered file ID to the color-information image processing section 34 in the previous time.

On the other hand, when the file ID selected as a processing object is stored in the cell-picture managing table, the analyzing section 31 provides the start address correlated to the file ID and stored in the cell-picture managing table to the color-information image processing section 34.

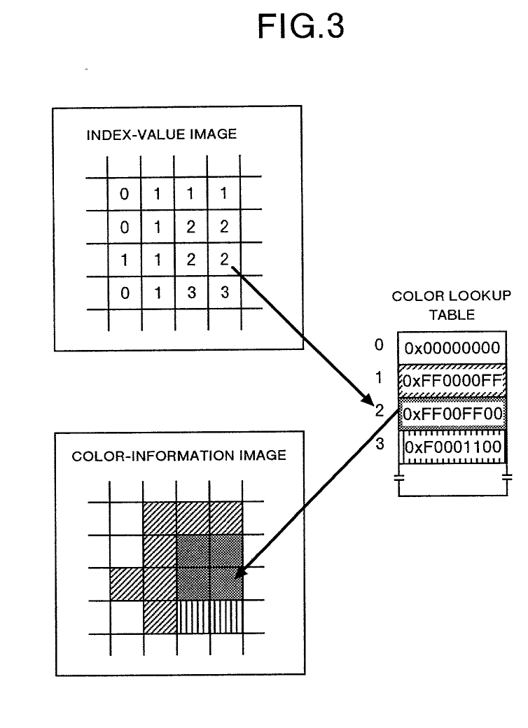

The color-information image processing section 34 with the file ID provided thereto from the analyzing section 31 converts the color-information image data in the file having the file ID to image data with a pixel value correlated to an index value (described as index-value image data hereinafter) by using the color lookup table prepared by the CLUT preparing section 33. Namely, the color-information image processing section 34 generates index-value image data capable of being instantly transformed back to the color-information image data by referring to the color lookup table as schematically shown in FIG. 3.

The color boundary diagram generating section 35 generates, according to index-value image data generated by the color-information image processing section 34 and from the image represented by the data, color boundary diagram data representing a color boundary diagram as an image obtained by extracting only pixels each with a different index value from that of the adjacent pixel in a specified direction.

The color boundary data generating section 36 generates, according to color boundary diagram data generated by the color boundary diagram generating section 35, color boundary data representing each color boundary existing on the color boundary diagram represented by the data, and provides the generated data to the file-write operating section 32. Namely, the color boundary diagram comprises pixels satisfying a condition such that each pixel should have a different index value from that of the adjacent pixel in a specified direction (the other pixels have only information indicating no satisfaction of the condition), but the pixels satisfying the condition can be classified into groups each consisting of pixels having the same index value and whose position on the diagram is adjacent to each other. In other words, the color boundary diagram can be handled as a group of curves represented by some pixels having the same color.

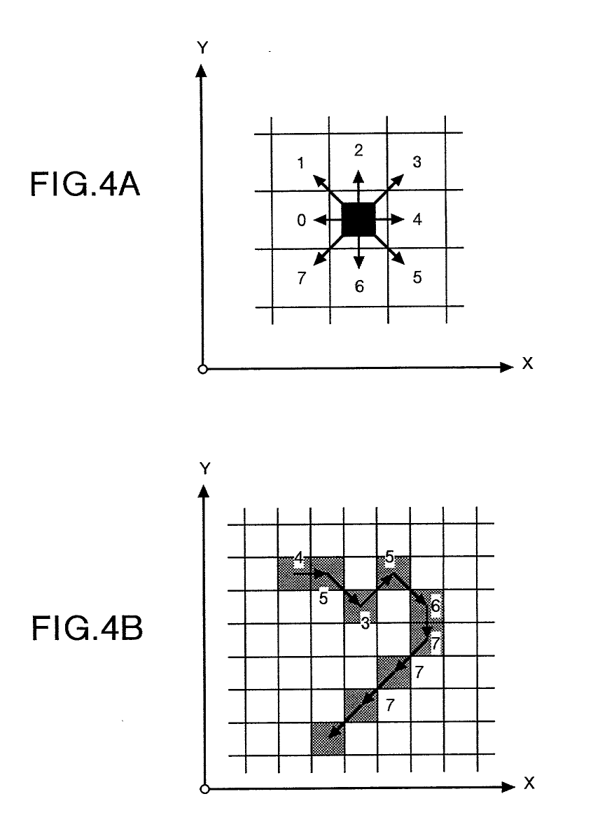

The color-boundary data generating section 36 is data indicating a curve (a color boundary) described above and generates color boundary data as data in which a chain code for representing the form is used for each color boundary included in the color boundary diagram, and provides the data to the file-write operating section 32. It should be noted that the chain code is a code of 0 to 7 each allocated to some pixel, as shown in FIG. 4A, according to a direction of its connection to a next pixel, and can represent a curve (a group of pixels) shown in FIG. 4B, by using this chain code, with coordinate values of a pixel at a trace start position and information of “45356777”.

The file-write operating section 32 adds, when the color boundary data is provided from the color-boundary data generating section 36, data including the data to the end of the compressed cell-moving picture file as frame data. Then, file-write operating section 32 registers information (start address) indicating a start position of the frame data in the file to a frame-start address table as a start address concerning a frame identified by a processing object frame number. Also a start address of the next frame data obtained from an end position of the written frame data this time is reported to the analyzing section 31. Then, the file-write operating section 32 increments the value of the processing object frame number by one and waits for receiving the next information.

The file-write operating section 32 registers, when a start address is provided from the analyzing section 31, the start address to the frame-start address table as a start address concerning a frame identified with a processing object frame number. Then the file-write operating section 32 increments the value of the processing object frame number by one and waits for receiving the next information.

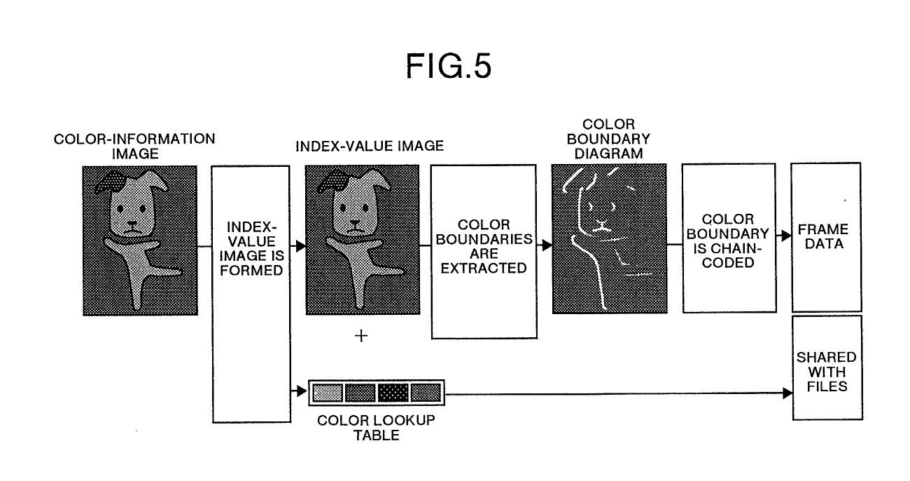

Namely, the apparatus generates, as schematically shown in FIG. 5, a color lookup table stored in the compressed cell-moving picture file according to color-information image data of cell pictures and an index-value image capable of decompression to the original color-information image data by this color lookup table. Then, the apparatus generates a color boundary diagram as an image obtained by extracting only the color boundaries from the index-value image, and further generates a color boundary data using chain code indicating each color boundary existing on the color boundary diagram. Then, the frame data containing the color boundary data generated for one color-information image data is stored in the compressed cell-moving picture file.

Preparation and storage of frame data is performed to color-information image data for all the cell pictures used for preparing moving pictures, but when there is a cell picture used in a plurality of frames in the moving pictures, a compressed cell-moving picture file including only one frame data concerning the cell picture is prepared.

For instance, it is assumed that the moving pictures as a processing object use cell-picture data A, B, and C in a 1st, n-2nd, and n-1st frames respectively and use the cell-picture data A again in a n-th frame. When the moving pictures are compressed, the file ID list where the 1st, n-2nd, and n-1st file IDs correspond to file IDs of the cell-picture data A, B, and C; and the n-th file ID corresponds to a file ID of the cell-picture data A is supplied to the cell-moving picture compressing section 23.

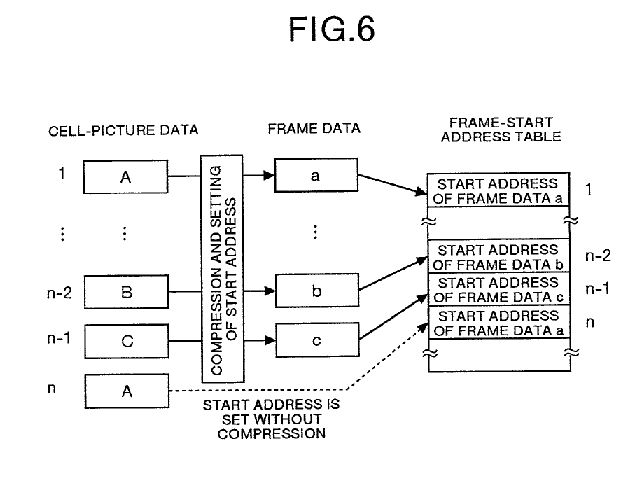

Accordingly, as schematically shown in FIG. 6, when processing is executed to the 1st, n-2nd, and n-1st file IDs, frame data a, b, and c as data obtained by compressing the cell-picture data A, B, and C is prepared, and start addresses of the frame data a, b, and c are set as a 1st, n-2nd, and an n-1st elements are set in the frame-start address table. On the other hand, when processing is executed to the n-th file ID, the frame data a concerning the cell-picture data A is already prepared, and so preparation of the frame data is omitted, and only the start address of the frame data a is set as an n-th element of the frame-start address table.

Detailed description is made for a sequence of decompressing compressed data (data in a compressed cell-moving picture file and a compressed background picture file) by the image processing apparatus 10. The decompressing section 27 (the cell-moving picture decompressing section 28 and background picture decompressing section 29) starts its operation when receiving startup instructing information consisting of a moving-picture name and operation-mode specifying information for specifying either a reproduction mode or a color edit mode as the operation mode. At first, description is made for an operation of the decompressing section 27 when the startup instructing information including the operation-mode specifying information for specifying the reproduction mode is received.

When receiving the startup instructing information including the operation-mode specifying information for specifying the reproduction mode, the background picture decompressing section 29 recognizes, by accessing the background picture managing file identified by the moving-picture name, control information such as reproduction rate information, some file IDs, and frame numbers for using the data in the compressed background picture file identified by each file ID or the like. Then, the background picture decompressing section 29 first identifies a compressed background picture file to be used in an initial frame according to a result of the recognition. Then, the background picture decompressing section 29 restores the data in the identified compressed background picture file and provides the data to the display 30.

Then, the background picture decompressing section 29 identifies a compressed background picture file to be used in the next frame. The background picture decompressing section 29 restores, when this identified compressed background picture file is different from the previously identified compressed background picture file, data in the previous compressed background picture file and provides the data to the display 30. On the other hand, the background picture decompressing section 29 provides, when this identified compressed background picture file is the same as the previously identified compressed background picture file, a result of decompressing data in the internally stored compressed background picture file to the display 30 again.

The background picture decompressing section 29 provides data to the display 30 in a cycle defined by reproduction rate information and in synchronism to a supply (details are described later) of data to the display 30 by the cell-moving picture decompressing section 28.

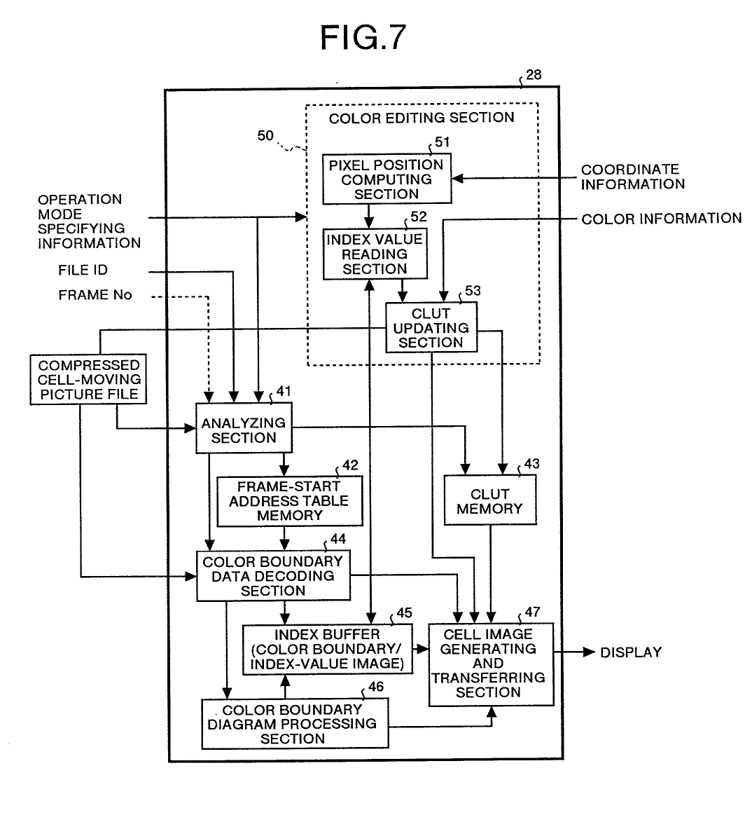

On the other hand, the cell-moving picture decompressing section 28 operates as follows. As shown in FIG. 7, the cell-moving picture decompressing section 28 comprises an analyzing section 41, a frame-start address table memory 42, a color boundary data decoding section 44, an index buffer 45, a color boundary diagram processing section 46, a color lookup table memory 43, and a cell image generating and transferring section 47. The cell-moving picture decompressing section 28 also has a color editing section 50, functioning only in a case of the color edit mode, comprising a pixel position computing section 51, an index value reading section 52, and a CLUT updating section 53.

When the startup instructing information including the operation-mode specifying information for specifying the reproduction mode is provided, the analyzing section 41 opens a compressed cell-moving picture file having a moving-picture name included in the startup instructing information, and reads out control information, a frame-start address table, and a color lookup table from the file. Then, the analyzing section 41 stores the read-out frame-start address table and color lookup table in the frame-start address table memory 42 and CLUT memory 43 respectively. Then, the analyzing section 41 gives control information to the color boundary data decoding section 44 and instructs execution of reproduction thereto.

When execution of reproduction is instructed, the color boundary data decoding section 44 reads the initial start address stored in the frame-start address table and reads the frame data starting from the start address from the compressed cell-moving picture file. Then, the color boundary data decoding section 44 decodes each color boundary data included in the frame data, and updates data in the index buffer 45 as a buffer for storing therein index-value image data. Namely, the color boundary data decoding section 44 sets data representing a color boundary diagram in the index buffer 45. When the processing to all the color boundary data is completed (when the color boundary diagram is prepared), the color boundary data decoding section 44 sends a notice to that effect to the color boundary diagram processing section 46.

The color boundary data decoding section 44 reads the next start address from the frame-start address table memory 42 when there occurs a timeout defined in reproduction rate information included in the control information after the previous start address is read out, and performs the processing described above according to the read-out start address. However, when this read-out start address is coincident with the previously read-out start address, the color boundary data decoding section 44 sends a notice to that effect to the cell image generating and transferring section 47.

When completion of the processing is noticed from the color boundary data decoding section 44, the color boundary diagram processing section 46 converts the color boundary diagram data in the index buffer 45 to ordinary image data. Namely, added to each pixel other than pixels constituting each color boundary of a color boundary diagram is an index value the same as that of a pixel positioned in a specified direction to the pixel and constituting the closest color boundary thereto, and through this operation, the color boundary diagram processing section 46 converts color boundary diagram data to its ordinary image data as the original image data. Then, the color boundary diagram processing section 46 sends a notice to the effect that the processing is completed to the cell image generating and transferring section 47.

The cell image generating and transferring section 47 converts, when completion of the processing is notices from the color boundary diagram processing section 46, index-value image data in the index buffer 45 to color-information image data by using the color lookup table stored in the CLUT memory 43, and provides the data to the display 30. The provision of the color-information image data to the display 30 is performed by successively providing color information of pixels constituting the image in a specified order, and in this case, the cell image generating and transferring section 47 operates in synchronism with the background picture decompressing section 29.

Namely, the cell image generating and transferring section 47 does not provide, when color information for a pixel whose color information should be sent out included in the color-information image data obtained by the transformation indicates a background color, the color information to the display 30, but the background picture decompressing section 29 storing therein color-information image data obtained by decompressing compressed background picture data provides color information concerning the corresponding pixel to the display 30. On the other hand, when color information for a pixel whose color information should be sent out does not indicate a background color, the cell image generating and transferring section 47 provides the color information to the display 30, but the background picture decompressing section 29 does not provide color information concerning the corresponding pixel to the display 30.

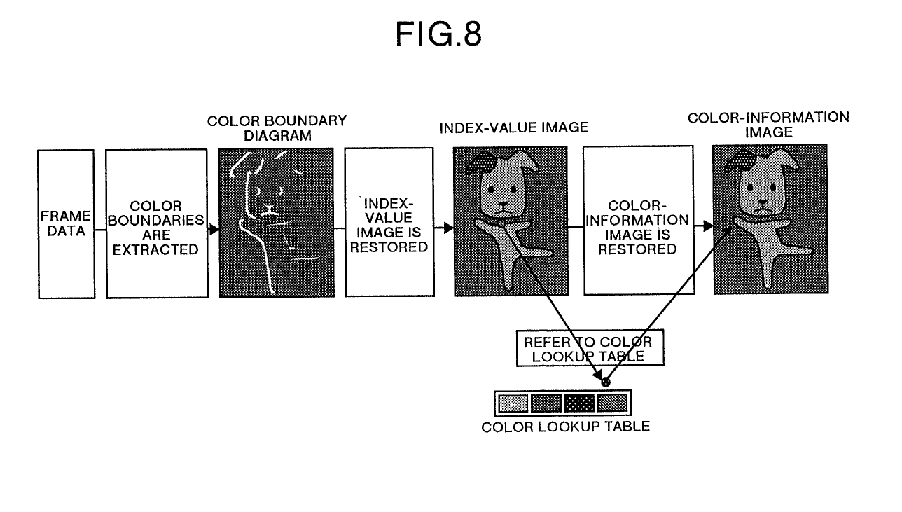

Namely, at the time of decompression, as schematically shown in FIG. 8, frame data is transformed to color boundary diagram data, and the color boundary diagram data is transformed to the ordinary image data as index-value image data. Then, the index-value image data is transformed to the color-information image data by referring the color lookup table, and used for display.

Next, description is made for operation of the decompressing section 27 when the startup instructing information including the operation-mode specifying information for specifying the color edit mode is received. At first, the operation of the cell-moving picture decompressing section 28 is described.

When the color edit mode is specified, the color boundary diagram processing section 46 and cell image generating and transferring section 47 operate in the same manner as that when the reproduction mode is specified. In contrast, the analyzing section 41 gives control information to the color boundary data decoding section 44 and instructs execution of reproduction thereto. After this operation, the analyzing section 41 shifts to a state of waiting for receiving a new frame NO from the operator through the information inputting section 21, and provides, when a new frame NO is given therefrom, the frame NO to the color boundary data decoding section 44.

On the other hand, when execution of decompression is instructed, the color boundary data decoding section 44 performs the same processing as that in the case where execution of reproduction is instructed to the initial start address stored in the frame-start address table. Namely, the color boundary data decoding section 44 generates color boundary diagram data according to the stored frame data in the index buffer 45 with the start address, and then sends a notice to the effect that the generation is completed to the color boundary diagram processing section 46.

However, the color boundary data decoding section 44 to which execution of decompression is instructed shifts to a state of waiting for receiving a frame NO from the analyzing section 41 thereafter. Then, the color boundary data decoding section 44 reads out, when a frame NO is provided, a start address identified by the frame NO from the frame-start address table memory 42, and generates color boundary diagram data from the frame data identified by the read-out start address.

Namely, when the color edit mode is specified, the color boundary data decoding section 44 functions as a section for generating color boundary diagram data concerning a frame with the frame NO specified by the operator in the index buffer 45. Then, the color boundary diagram processing section 46 and cell image generating and transferring section 47 operate entirely the same as that when the reproduction mode is specified. However, the cell-moving picture decompressing section 28 functions as a section for providing image data for cell pictures concerning the frames with the frame NOs specified by the operator to the display 30 when color edit mode is specified.

The background picture decompressing section 29 also functions as a section for providing image data for a background picture concerning the frame with the frame NO specified by the operator to the display 30, so that the pictures concerning the frames with the frame NOs, of the moving pictures, specified by the operator are resultantly displayed on the screen of the display 30.

The color editing section 50 in the cell-moving picture decompressing section 28 starts it operation after receiving the operation mode specifying information for specifying a color edit mode, and its standby state of receiving coordinate value information as well as color information from the information inputting section 21 is effected. It should be noted that coordinate information inputted into the color editing section 50 is information indicating a position of a pixel in an area specified by the operator to specify the area in which a color has to be changed by using a screen coordinate system of the display 30. The color information inputted into the color editing section 50 is regarded as information to be added to each pixel in the area and specified by the operator.

The pixel position computing section 51 computes a pixel position as coordinate information of a pixel identified by the coordinate information on the index value coordinate system from the coordinate information inputted into the color editing section 50. The index value reading section 52 accesses the index buffer 45 with the pixel position computed by the pixel position computing section 51 and reads an index value that each pixel in the area specified by the operator holds.

The CLUT updating section 53 changes color information in the CLUT memory 43 correlated to the index value read by the index value reading section 52 to color information provided from the information inputting section 21. The CLUT updating section 53 changes the color lookup table in the compressed cell-moving picture file in the same manner as described above. Then the CLUT updating section 53 instructs re-transfer of the color-information image data to the display 30 to the cell image gene-rating and transferring section 47.

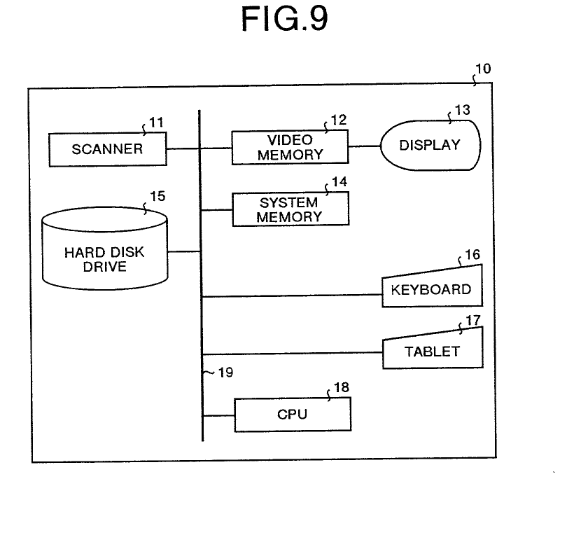

Further specific description is made hereinafter for the configuration and operation of the image processing apparatus according to the embodiment of the present invention. FIG. 9 shows hardware configuration in outline of the image processing apparatus 10 according to the embodiment. As shown in the figure, the image processing apparatus 10 according to the embodiment comprises a scanner 11, a video memory 12, a display 13, a system memory 14, a hard disk drive 15, a keyboard 16, a tablet 17, a CPU 18, and a bus 19 for connecting those components to each other.

The scanner 11 generates image data consisting of a 32-bit length of color information according to a picture drawn on paper. The scanner 11 is a main section of the reading section 22 in the functional block diagram, and is used for generating color-information image data of a background picture or a cell picture.

The video memory 12 is a memory for storing therein one screenful of image data (32 bits), and the display 13 is a means for displaying the image data in the video memory 12 on the screen thereof. It should be noted that the section consisting of the video memory 12 and display 13 corresponds to the display 30 in the functional block diagram.

The keyboard 16 and tablet 17 are the means for inputting various information into the image processing apparatus 10 (CPU 18), and the information inputting section 21 comprises those components and the CPU 18. It should be noted that the keyboard 16 is used for inputting an instruction to execute various type of processing as well as data required for each of the processing, while the tablet 17 is used for inputting coordinate information (to specify an area in which color is changed) when color edits are performed.

The system memory 14 is a memory for storing therein the operating system and a moving-picture processing program (details thereof are described later). The system memory 14 is also used as a work area. The hard disk drive 15 is a device for storing therein compressed cell-moving picture files and compressed background picture files, and corresponds to the memory 26 in the functional block diagram. The hard disk drive 15 is used for storing therein the operating system and cell-moving picture processing program.

The CUP 18 is a unit for integrally controlling each section through the bus 19, and reads the operating system stored in the hard disk drive 15 into a specified storing area of the system memory 14. Then, the CPU 18 starts its operation according to the operating system, and reads the moving-picture processing program stored in the hard disk drive 15 into the system memory 14 when it is detected that the specified operation is executed through the keyboard 16. Then, the CPU 18 starts its controls over each section according to the moving-picture processing program in the system memory 14.

The processing executed by the CPU according to the moving-picture processing program can be largely divided into processing of compression and decompression as clearly understood from the description with reference to the functional block diagram having been made.

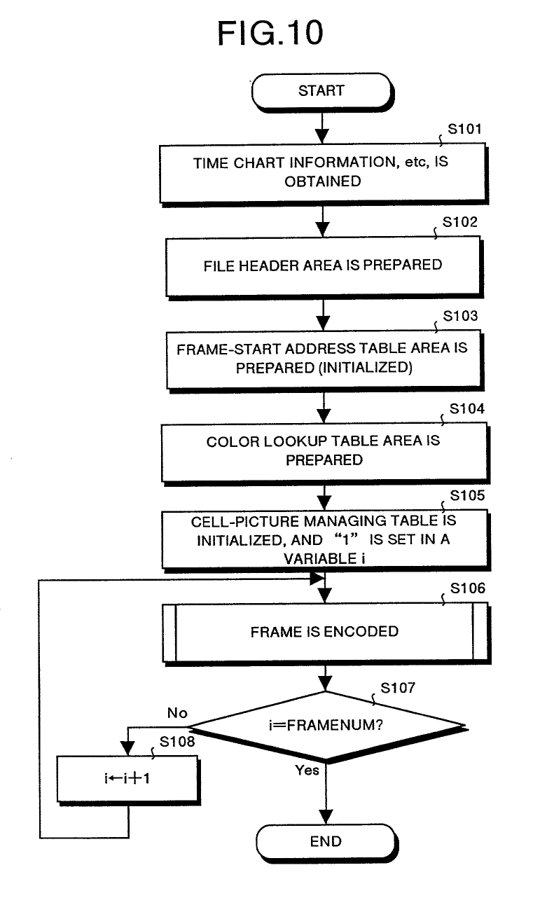

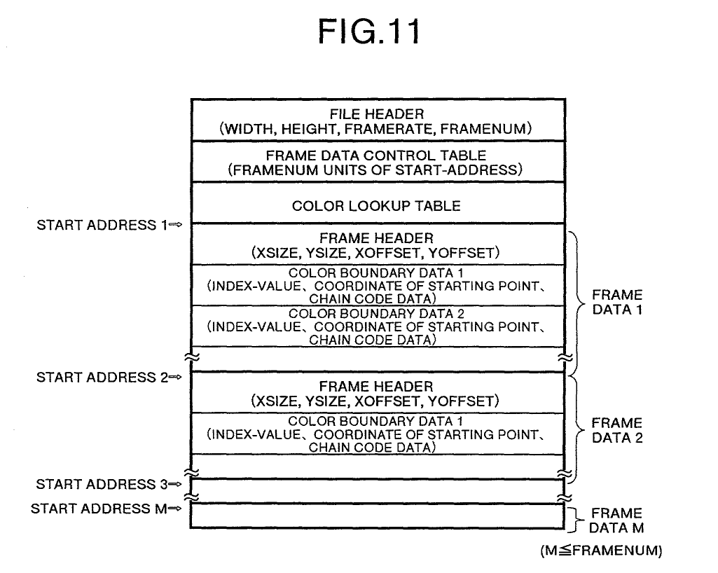

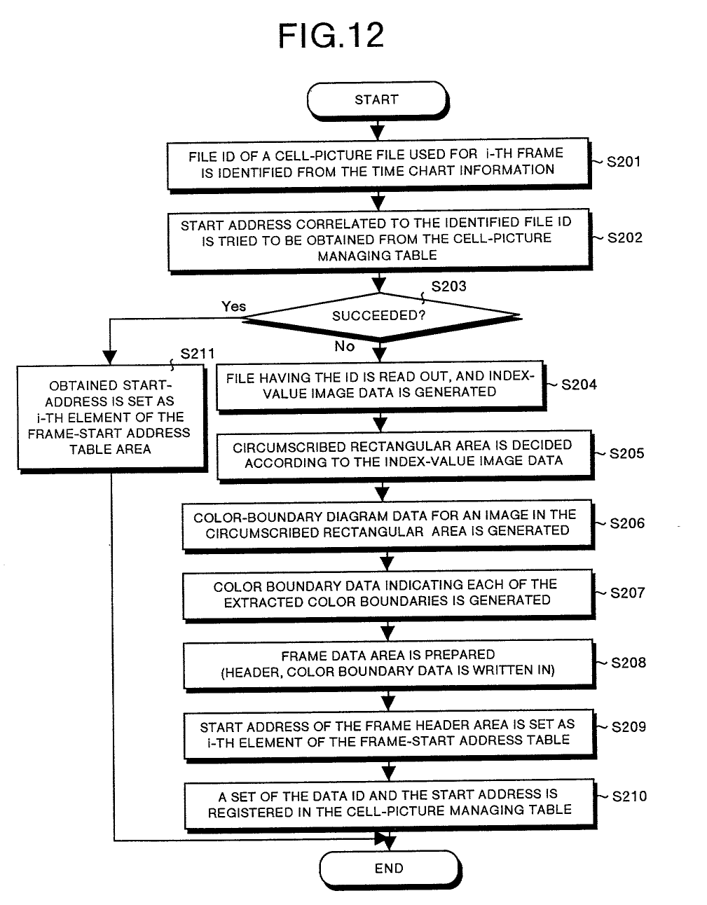

At first, description is made for a sequence of the operation (a sequence of controls) of the CPU 18 when compression is executed with reference to FIG. 10 to FIG. 14B. It should be noted that, of those figures, FIG. 10 is a flow chart showing a sequence of the operation of the CPU 18 when compression processing is executed in a case where cell-picture files and the color lookup table have already been prepared with the operation of generating a compressed cell-moving picture file as a core thereof. FIG. 11 is a view showing configuration of the compressed cell-moving picture file, and FIG. 12 is a flow chart of frame encoding processing executed at the time of compression processing.

When compression is executed in the situation where the cell-picture file is prepared, as shown in FIG. 10, the CPU 18 first executes the processing to obtain time chart information from the operator in an interactive manner (step S101). Namely, the CPU 18 obtains “FRAMENUM” for a total frame number and “FRAMERATE” for a reproduction rate from the operator, and also obtain information for specifying file IDs of cell-picture files with color-information image data of cell pictures used for moving pictures stored therein as well as more than one frames to be used for data in the files with the file IDs therefrom. The CPU 18 also obtain the similar information concerning background pictures and a moving-picture name used as identifying information for compression cell-moving picture files or the like.

Following the completion of obtaining of the time chart information or the like, the CPU 18 prepares a file header area, a frame data management table area, and a color lookup table area each as one area (component) of a compressed cell-moving picture file (steps S102 to S104).

Herein, detailed description is made for each processing in steps S102 to S104 with reference to FIG. 11 showing a structural view of the compressed cell-moving picture file. As shown in the figure, the compressed cell-moving picture file is a file consisting of a file header, a frame-start address table, a color lookup table and a plurality (M in number in the figure) of frame data.

The file header is an area in which width information “WIDTH”, height information “HEIGHT”, information “FRAMERATE” for a reproduction rate, and information “FRAMENUM” for a total frame number are set, and in step S102, the CPU 18 prepares the file header area by writing those already obtained four types of information in the header of the compressed cell-moving picture file and on.

As the frame-start address table is a table capable of storing therein start addresses of frame data for the total frame number, during the execution in step S103, the CPU 18 insures an area, for the frame-start address table, in which start addresses in the same number as the total frame number “FRAMENUM” set in the file header can be set. Then in step S104, the CPU 18 prepares the color lookup table area by writing contents of the already prepared color lookup table in immediately behind the insured area.

Following the completion of preparing the color lookup table area, the CPU 18 starts the processing for storing compressed data indicating each cell picture in the compressed cell-moving picture file (steps S105 to S108), and, at first, initializes the cell-picture management table and also initializes a variable i to “1” (step S106). As already described, the cell-picture management table is a table for storing therein a correlation between file IDs and start addresses, and in step S105, the CPU 18 prepares an empty (having no element) cell-picture management table. Then, the CPU 18 executes the processing of frame encoding (step S106).

As shown in FIG. 12, when the frame encoding is processed, the CPU 18, at first, identifies a file ID for a cell-picture file to be used in an i-th frame from the time chart information (step S201). Namely, the CPU 18 obtains the i-th element of the file ID list. Then, the CPU 18 tries to obtain a start address correlated to the obtained file ID from the cell-picture management table (step S202).

When the start address can not be obtained (step S203; No), the CPU 18 reads the contents of the cell-picture file identified by the file ID from the hard disk drive 15 into the system memory 14, and generates index-value image data correlated to the color-information image data by using the already read-out color lookup table (step S204).

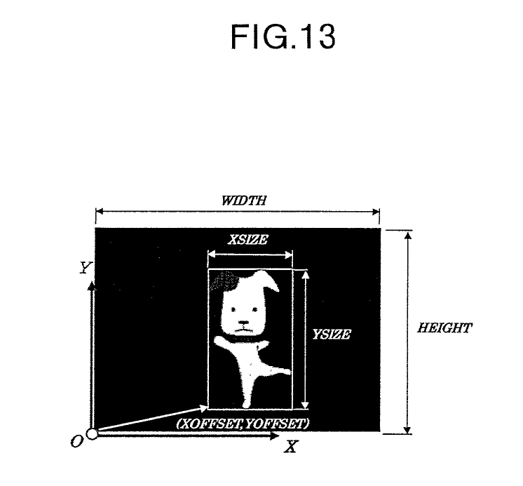

The CPU 18 performs the processing for deciding a circumscribed rectangular area to the generated index-value image data (step S205). Namely, the CPU 18 decides, as shown in FIG. 13, a circumscribed rectangular area as a rectangular area including a non-background-color area comprising “WIDTH”×“HEIGHT” pieces of pixel on the cell image and a minimum rectangular area having parallel sides in the X axis or the Y axis thereof. More specifically, the CPU 18 obtains coordinates (XOFFSET, YOFFSET) of the vertex closest to the origin and size information (XSIZE, YSIZE) of the circumscribed rectangular area.

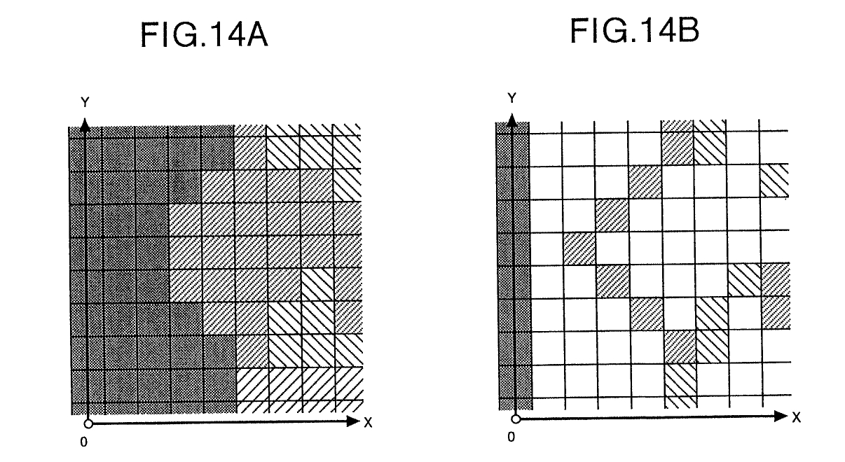

Then, the CPU 18 generates color boundary diagram data for cell images within the decided circumscribed rectangular area (step S206). Namely, as schematically shown in FIGS. 14A and 14B, the CPU 18 generates, from the index-value image data (FIG. 14A), color boundary diagram data (FIG. 14B) representing an image consisting of only pixels each with a different index value from that of the adjacent pixel in the left side (Y-axial coordinate values of adjacent pixels are the same, while an X-axial coordinate value of a pixel is by “1” less than that of the other pixel thereof).

Then, the CPU 18 extracts color boundaries existing on the color boundary diagram represented by the color boundary diagram data, and generates color boundary data as data indicating the extracted color boundaries and using chain codes (step S207). More specifically, in this step, the CPU 18 retrieves color boundaries existing on the color boundary diagram represented by the data, namely a series of pixel groups each having the same index value.

Then, the CPU 18 prepares, for each of the retrieved pixel groups (color boundaries), data in which each form thereof is indicated by chain codes (described as chain code data hereinafter), and generates an index value that pixels constituting a color boundary commonly have and color boundary data as data with a coordinate of a pixel in correlation to an initial chain code in front of the chain code data. It should be noted that a length of a chain code data is different depending on each color boundary, and so, in this embodiment, 4-bit data whose lower 3 bits indicate a direction of a bit string and the most significant bit is data indicating presence or absence of any following pixel is used as a chain code so that an end position of the boundary can be recognized.

Following the generation of color boundary data, the CPU 18 prepares, by writing the frame header consisting of information indicating a position as well as a size of the circumscribed rectangular area and all the generated color boundary data in the end thereof and on, a frame data area concerning cell-image data read-out in step S204 in the compressed cell-moving picture file (step S208). Then, the CPU 18 sets a start address of the prepared frame data area as an i-th element of the frame-start address table in the compressed cell-moving picture file (step S209). The CPU 18 registers a set of the file ID and start address in the cell-picture management table (step S210) and ends the processing of frame encoding.

On the other hand, when the start address correlated to the first file ID can be obtained from the cell-picture management table (step S203; Yes), namely when a frame data concerning the cell image data identified by the file ID has already been prepared, the CPU 18 sets the obtained start address as an i-th element of the frame-start address table (step S211), and ends the processing of frame encoding.

Following the completion of frame encoding, the CPU 18 determines, as shown in FIG. 10, whether the value of the variable i is coincident with the total frame number “FRAMENUM” (step S107) When it is determined that both of the values are not coincident with each other (step S107; No), the CPU 18 adds “1” to the variable i (step S108). Then, the processing from step S106, namely the processing-of frame encoding to the next file ID is executed. On the other hand, when it is determined that the value of the variable i is coincident with “FRAMENUM” (step S107; Yes), the processing to all the file IDs in the file ID list is completed, and so the CPU 18 ends the compression.

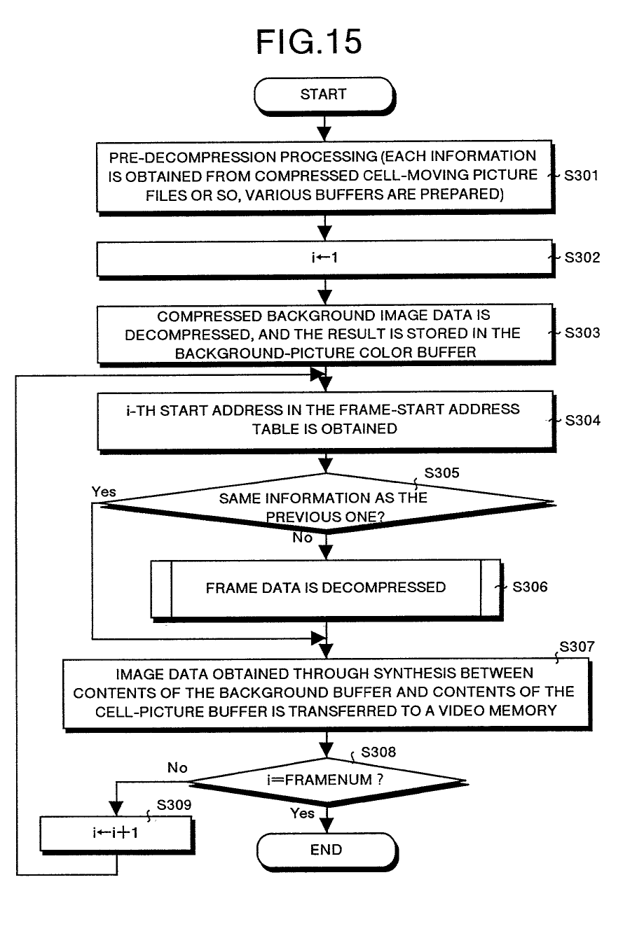

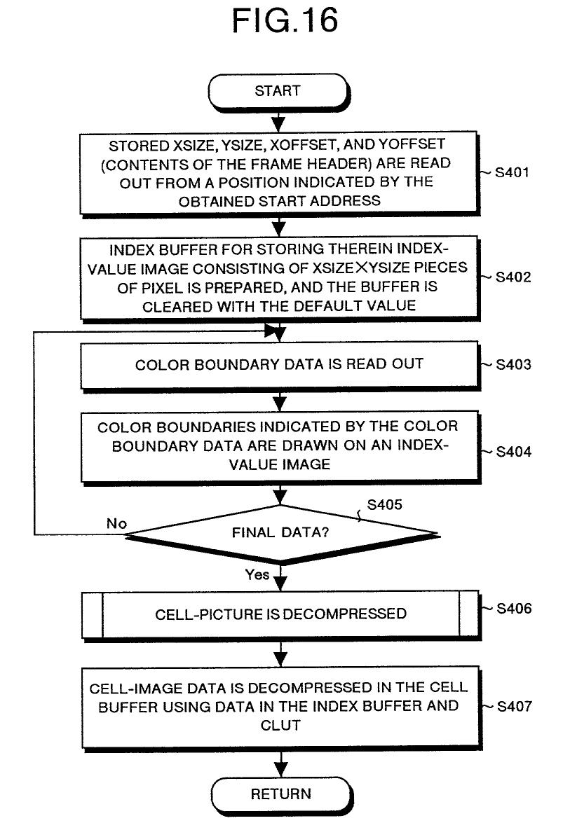

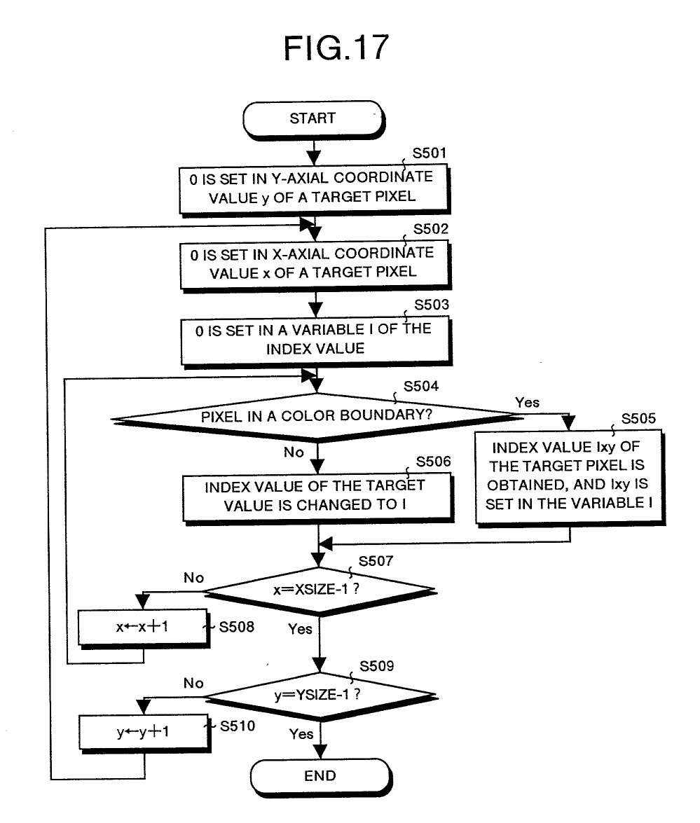

Next, description is made for the operation of the CPU 18 for decompression processing with reference to FIG. 15 through FIG. 18. FIG. 15 is a flow chart showing an operational sequence of the CPU 18 when compressed data concerning moving pictures using one sheet of background picture is restored. FIG. 16 and FIG. 17 are flow charts showing operational sequences of the CPU 18 for the processing of frame-data decompression shown in FIG. 15 and the processing of cell-picture decompression respectively.

When execution of decompression is instructed, the CPU 18 identifies a background-picture managing file and a compressed cell-moving picture file identified with a moving-picture name given together with the instruction. Then, the CPU 18 obtains file IDs of the background picture file required for decompressing the moving pictures from the identified background-picture managing file, and also identifies in which frame each data for the files identified by the file IDs is used. The CPU 18 reads the file header, frame-start address table, and color lookup table from the identified compressed cell-moving picture file.

Namely, the CPU 18 performs the processing of reading the file header by reading four fixed-length data (“WIDTH”, “HEIGHT”, “FRAMENUM”, and “FRAMERATE”) from the header of the compressed cell-moving picture file. Then, the CPU 18 performs the processing of reading the frame-start address table by reading the start addresses in the same number as that of the “FRAMENUM”, and reads the color lookup table as a fixed-length table. The CPU 18 prepares two buffers (a buffer for background pictures, a buffer for cell pictures) where “WIDTH”×“HEIGHT” pieces of color information can be stored in the system memory.

In the following step, the CPU 18 sets “1” in a variable i used for storing a frame number to be restored (displayed) (step S302). Then, the CPU 18 restores the compressed background image data and stores a result of the decompression in the background buffer (step S303).

In the following step, the CPU 18 obtains the i-th start address in the frame-start address table read-out onto the system memory 14 (step S304), and determines whether the start address is coincident with the previously obtained start address or not (step S305). When both the addresses are not coincident with each other (step S305; No), the CPU 18 executes decompression of frame data (step S306) as processing to prepare a result of decompressing new frame data in the cell-picture buffer.

As shown in FIG. 16, when the frame data is restored, the CPU 18 first reads “XSIZE”, “YSIZE”, “XOFFSET”, and “YOFFSET” (namely, contents of the frame header) from the position identified with the start address obtained in step S304 (step S401). The CPU 18 prepares an index buffer where index-value image data consisting of “XSIZE”×“YSIZE” pixels can be stored in the system memory 14, and clears the index buffer with the default value “255” (0×FF) (step S402).

Then, the CPU 18 reads one of color boundary data from the compressed cell-moving picture file (step S403), and draws a curve according to the read-out color boundary data on the index-value image (step S404). Namely, the CPU 18 reads an index value Ic and start-point coordinate values Xc, Yc from the compressed cell-moving picture file, and further keeps on reading 4-bit chain codes until a chain code in which the most significant bit is “1” appears. Then, the CPU 18 decides a pixel value of a series of pixels starting with the pixel whose coordinates are Xc, Yc and are related to each other as shown by the read-out chain code group to Ic.

Following the completion of this processing to all the color boundary data (step S405; Yes), the CPU 18 performs cell-picture decompression as the processing of decompressing ordinary image data from the color-boundary image data (step S406).

As shown in FIG. 17, when the cell picture is restored, the CPU 18 first sets “0” in a Y-axial coordinate value y of a target pixel as a pixel to be processed (step S501), and sets “0” in an X-axial coordinate value x of a pixel as an object for processing (step S502). Further, the CPU 18 sets “0” (0×00) in a variable I in the index value (step S503), and determines whether the target pixel is a pixel constituting a color boundary or not according to the index-value image data (step S504). Namely, it is determined whether the index value of the pixel with its coordinate values (x, y) is a value other than the default value or not.

When it is determined that the target pixel is a pixel constituting the color boundary (step S504; Yes), the CPU 18 sets the index value Ixy in the variable I (step S505), and the processing shifts to step S507. When it is determined that the target pixel is not a pixel constituting the color boundary (step S504; No), the CPU 18 changes the index value of the target pixel to I (step S506), and the processing shifts to step S507.

In step S507, the CPU 18 determines whether the value of x is equal to “XSIZE-1” as the maximum value of the X-axial coordinate value of the target image or not. Then, when it is determined that x is not equal to “XSIZE-1” (step S507; No), the CPU 18 increments the value of x by “1” (step S508), and executes the processing from step S504 again.

On the other hand, when it is determined that x is equal to “XSIZE-1” (step S507; Yes), the CPU 18 determined whether the value of y is equal to “YSIZE-1” as the maximum value of the Y-axial coordinate value of a pixel constituting the target image or not, and when it is determined that y is not equal to “YSIZE-1” (step S509; No), the CPU 18 increments the value of y by “1” (step S510), and executes the processing from step S502.

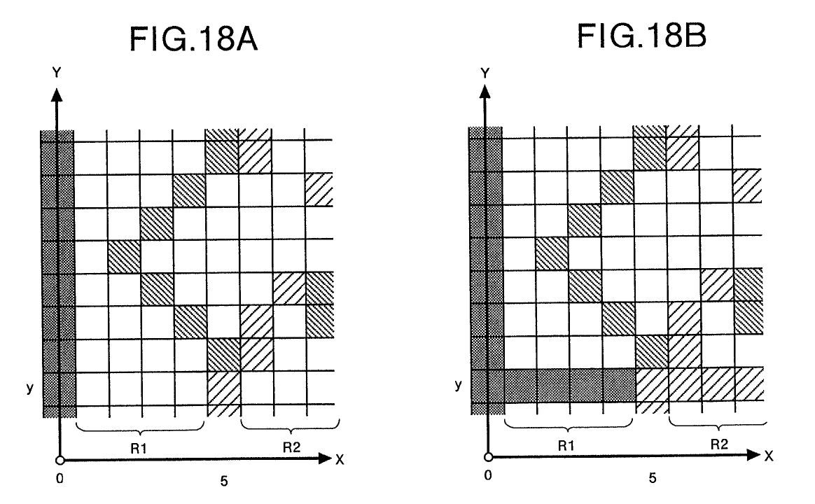

Namely, the color boundary diagram represented by the color boundary diagram data generated from the frame data is obtained as shown in FIG. 18A. It should be noted that each rectangle shaded with dots in the figure shows a pixel constituting a color boundary, and each color-boundary pixel existing at a position of X=0 is each color-boundary pixel of the background color. Each rectangle not shaded with dots shows a pixel with the default value added thereto.

When the line indicated by Y=y of this color boundary diagram is an object to be processed, the CPU 18 first reads out index values of target pixels at a position indicated by (X, Y) =(0, y). Then, as the read-out index values are not default values, the CPU 18 determines that the target pixels are pixels constituting a color boundary, and changes the index value I to “0”. Then, the CPU 18 reads out a pixel at a position indicated by (X, Y)=(1, y).

In this case, as the read-out index value is the default value, the CPU 18 determines that the target pixel is not a pixel constituting a color boundary, and rewrites the index value of the target pixel to I. Then, the CPU 18 executes the same processing as described above to each pixel in an area with a reference sign R1 allocated thereto, and so, as shown in FIG. 18B, the same index value as that of the pixel constituting the color boundary positioning at X=0 as the closest color boundary positioning in the left direction of the pixels in the area R1 is assigned to each of the pixels in the area R1.

In the following step, when a pixel at the position indicated by (X, Y)=(5, y) is a target pixel, an index value different from the default value is read out, so that the CPU 18 sets the index value in I. Accordingly, as shown in FIG. 18B, the same index value as that of the pixel positioned indicated by (X, Y)=(5, y) is given to each pixel whose index value is the default value in an area with a reference sign R2 allocated thereto.

Then, as the CPU 18 executes the same processing as described above to each line, data representing the original image (Refer to FIG. 14) is generated after all in the index buffer when decompression of the cell picture is completed.

Following the completion of decompressing the cell picture, as shown in FIG. 16, the CPU 18 restores cell image data in the cell-picture buffer by using the index-value image in the index buffer and color lookup table (step S407). Namely, the index-value image existing in the index buffer when decompression of the cell picture is completed corresponds to an image within the circumscribed rectangular area, so that the CPU 18 performs processing required for decompressing the image to color-information image data of the original cell picture in this step.

More specifically, the CPU 18 clears the cell-picture buffer in which a color-information image comprising “WIDTH”×“HEIGHT” pieces of pixels can be stored with color information for a background color. Then, the CPU 18 generates color-information image comprising “XSIZE”×“YSIZE” pieces of pixels corresponding to the index-value image in the index buffer by using the color lookup table. Then, the CPU 18 keeps on writing each color information constituting color-information image into the cell-picture buffer so that the restored color-information image is included in a position defined by “XOFFSET” and “YOFFSET”.

After the cell image data is decompressed in the cell-picture buffer, the CPU 18 ends decompression of the frame data, and transfers the image data obtained by synthesizing the contents of the background-picture buffer to the contents of the cell-picture buffer to the video memory 12 as shown in FIG. 15 (step S307). Namely, as for a pixel to be transferred, the CPU 18 transfers, when a pixel whose color information stored in the cell-picture buffer is color information concerning a background color, color information in the background-picture buffer to the video memory 12, and transfers, when pixels are those other than the pixel, color information in the cell-picture buffer. It should be noted that processing in step S307 is executed when the time defined by “FRAMERATE” (“1/FRAMERATE” sec) has elapsed since the execution time of the previous processing in step S307 although the figure is omitted herein.

Then, the CPU 18 compares the value of the variable i to “FRAMENUM” (step S308). When it is found that the value of i is not equal to “FRAMENUM” (step S308; No) the CPU 18 adds “1” to the variable i (step S309), returns to step S304, and obtains the i-th start address from the frame-start address table.

The case where the obtained start address is the same as the previously obtained start address (step S305; Yes) indicates that there exist (remains) cell image data required for displaying the next frame in the cell-picture buffer, hence the processing shifts to step S307 without execution of frame-data decompression.

The CPU 18 repeats the processing described above, and ends the decompression processing when the value of the variable i is equal to “FRAMENUM”.

It should be noted that, when moving pictures use a plurality of background pictures, the CPU 18 determines, after execution in step S309, whether the background picture used in the next frame (i-th frame) is a new background picture or not (whether rewriting of the background buffer is required or not) Then, when it is determined that the background picture used in the next frame (i-th frame) is a new background picture, the processing is returned to step S303, a result of decompressing compressed background-picture data for the new background picture in the background buffer is prepared and the processing in step S304 and thereafter is executed.

In step S402, the index buffer is cleared with the default value “255”, that is because a pixel on a color boundary of the background color is discriminated from a pixel not positioning on the color boundary with an index value in the index buffer after drawing of the color boundary is completed, so that, in order to obtain the same effect as described above, there may be employed a method of storing a result of decompressing the color-boundary data in any buffer other than the index buffer, making determination in step S504 according to data in the buffer, and clearing the index buffer with the index value “0” of the background color in step S402.

As described above, the image processing apparatus 10 according to the embodiment compresses cell pictures and background pictures used for preparation of moving pictures with a different compression method. As for a cell picture, frame data including a plurality data representing a plurality of color boundaries extracted from the image with chain codes respectively is decided as compressed data. This frame data can be decompressed to the original image data through extremely easy processing, so that the image processing apparatus 10 according to the embodiment allows moving pictures to quickly be reproduced without giving any influence over other processing. Accordingly, the moving pictures using cell pictures can efficiently be processed.

The image processing apparatus according to the embodiment can be modified in various ways. For instance, the apparatus can be modified so that an index-value image is not prepared. Namely, the apparatus may be so configured that a color boundary diagram can be obtained directly from a color-information image and color-boundary data representing each color boundary on the color boundary diagram is generated. The apparatus may also be configured such that it does not have the sections for compressing and decompressing of a background picture. Namely, the apparatus may be configured so as to target only the moving pictures comprising cell pictures.

It is needless to say that the image processing apparatus maybe realized as a dedicated apparatus, but an ordinary computer may also be made to operate as the image processing apparatus by installing a specified program thereon through a communication line or a transportable storage medium.

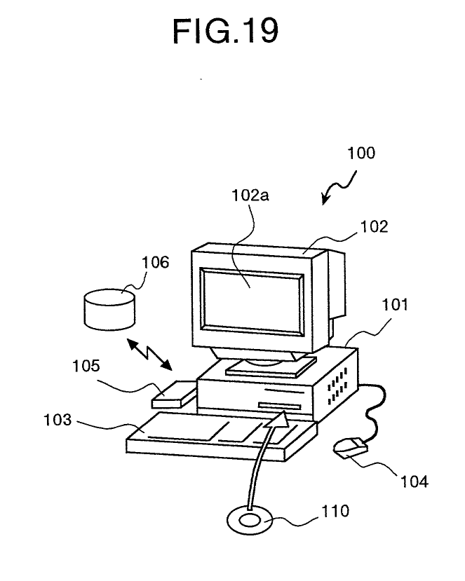

More specifically, the ordinary computer 100 comprises, as shown in FIG. 19, a main unit 101 with built-in CPU and disk drive or the like, a display 102 for displaying an image corresponding to signals from the main system 101 on a screen 102a, a keyboard 103 for entering various information to be supplied to the main system 101, a mouse 104 for specifying an arbitrary position on the screen 102a, and a modem 105 for performing data transaction with an external machine through a communication line.

When the computer 100 is made to operate as an image processing apparatus, the program stored in a transportable storage medium 110 is installed on the disk drive built in the main unit 101 therefrom, and the installed program may be executed by the CPU. Otherwise the program stored in the transportable storage medium 110 such as a CD-ROM, an MO, a floppy disk, or IC card memory may directly be executed by the CPU. Further, by downloading the program stored in a memory 106 of other computer to the computer 100 through a communication-line control unit such as the modem 105, the computer 100 can also be made to operate as an image processing apparatus.

It should be noted that the computer 100 shown in the figure has no hardware corresponding to the reading section 22 (Refer to FIG. 1), in such a case, in the image processing apparatus having the configuration described above, image data is supplied to the main unit through the modem 105 or the transportable storage medium 110.

As described above, with the image processing apparatus and the image processing method according the present invention, an image can reversibly be compressed to data, which enables reduction of a required time for compression thereof. In addition, the data can be decompressed, so that, for instance, image data for cell pictures can efficiently be managed and edited by using the data. Furthermore, a computer can be made to operate as the image processing apparatus described above.

With the image processing apparatus according to the present invention, an image can reversibly be compressed to data with which a time required for its decompression is further reduced, and the data can also be decompressed.

With the image processing apparatus according to the present invention, moving pictures comprising a plurality of images can reversibly be compressed to data with which a time required for their decompression is reduced, and the data can also be decompressed.

With the image processing apparatus according to the present invention, moving pictures whose identical image is used for a plurality of frames can reversibly be compressed to data with which a time required for their decompression is reduced and with a smaller size, and the data can also be decompressed.

With the image processing apparatus according to the present invention, an image with a few step gradation can reversibly be compressed to data with which a time required for its decompression is reduced, and the data can also be decompressed.

With the image processing apparatus according to the present invention, moving pictures consisting of cell pictures and background pictures combined with each other can be compressed to data with which a time required for their decompression is reduced, and the data can also be decompressed.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An image processing apparatus comprising:
a pixel retrieving unit for retrieving all pixels each having a color different from that of the adjacent pixel in a specified direction among pixels constituting an image;
a color boundary retrieving unit for retrieving all color boundaries each as a group of continuous pixels having the same color among the pixels retrieved by said pixel retrieving unit;
a color boundary data generating unit for generating color boundary data, for each of the color boundaries retrieved by said color boundary retrieving unit, including chain code data indicating a position as well as a form of each color boundary and information indicating a color that pixels constituting the color boundary commonly have; and
an output unit for outputting data including all the color boundary data generated by said color boundary data generating unit as compressed image data concerning the image.

2. An image processing apparatus according to claim 1; wherein said pixel retrieving unit retrieves all pixels each having a different color from that of the adjacent pixel in a specified direction among pixels in an area surrounded by all the pixels existing outside thereof having a particular color, and
said output unit outputs data including the area information indicating a position as well as a form of the area where the pixels are retrieved by said pixel retrieving unit as compressed image data concerning the image.

3. An image processing apparatus according to claim 1 further comprising:
a compressed moving-picture data output unit for outputting compressed moving-picture data including a plurality of compressed image data in a form showing an order of using the compressed image data outputted by said output unit as a result that each of the plurality of images is processed by said pixel retrieving unit respectively.

4. An image processing apparatus according to claim 1 further comprising:
a compressed moving-picture data output unit for outputting compressed moving-picture data including a plurality of compressed image data outputted by said output unit as a result that each of the plurality of images is processed by the image retrieving unit, and also compressed moving-picture data including data correlating each of the compressed image data to an order of using each data in a format in which the identical compressed image data can be rearranged according to different orders of use.

5. An image processing apparatus according to claim 1 further comprising:
a table information preparing unit for preparing table information for correlating index values different to each other to all types of colors that pixels constituting the image have; wherein;
said color boundary data generating unit generates color boundary data including an index value correlated to each color by the table information as information representing color, and said compressed image data output unit outputs data including all the color boundary data generated by said color boundary data generating unit as well as the table information as compressed image data concerning the image.

6. An image processing apparatus according to claim 1 further comprising:
a compressed background image data generating unit for compressing image data for a background image used as a background of the image whose pixels are retrieved by said pixel retrieving unit in a specified compression method and generating compressed background image data.

7. An image processing apparatus comprising:
a color boundary diagram generating unit for generating, according to compressed image data including a plurality of color boundary data each representing a color boundary with continuous pixels having the same color and comprising chain code data and information indicating colors, a color boundary diagram as an image having a plurality of color boundaries represented by the plurality of color boundary data; and
a decompressed image generating unit for generating a decompressed image as an image obtained by allocating, to each of pixels not constituting any color boundary within the color boundary diagram generated by said color boundary diagram generating unit, the same color as that of a pixel positioned in a specified direction to the pixel and constituting the closest color boundary thereto.

8. An image processing apparatus according to claim 7; wherein the compressed image data includes area information indicating a position and a form of an area indicated by itself, and said color boundary diagram generating unit generates, according to the compressed image data, a color boundary diagram as an image having a plurality of color boundaries indicated by the plurality of color boundary data in an area indicated by the area information with all pixels existing outside of the area having a particular color.

9. An image processing apparatus according to claim 7 further comprising:
a compressed moving-picture data processing unit as a unit functioning according to compressed moving-picture data including a plurality of compressed image data in a format showing an order of using the data for making said color boundary diagram generating unit process each compressed image data included in the compressed moving-picture data according to the order of using the data.

10. An image processing apparatus according to claim 7 further comprising:
a compressed moving-picture data processing unit as a unit functioning according to compressed moving-picture data including a plurality of compressed image data as well as to compressed moving-picture data including data correlating each of the compressed image data to an order of using each data in a format in which the identical compressed image data can be rearranged according to different orders of use for making said color boundary diagram generating unit process each compressed image data included in the compressed moving-picture data according to the order of using the data.

11. An image processing apparatus according to claim 7; wherein the compressed image data includes color boundary data comprising table information for correlating an index value to each color, chain code data, and index values as information indicating colors, and said decompressed image generating unit generates an image by allocating, to each of pixels not constituting any color boundary within the color boundary diagram generated by said color boundary diagram generating unit, the same index value as that of a pixel positioned in a specified direction to the pixel and constituting the closest color boundary thereto, and generates a decompressed image as an image obtained by allocating a color correlated to an index value of each pixel constituting the image thereto with the table information.

12. An image processing apparatus according to claim 11 further comprising:
a rewriting unit for rewriting contents of table information included in the compressed image data according to inputted information.

13. An image processing apparatus according to claim 7 further comprising:
a background image generating unit for decompressing the compressed background image data and generating a background image; and
a superimposing unit for generating an image with a decompressed image generated by said decompressed image generating unit superimposed on a background image generated by said background image generating unit.

14. An image processing method comprising:
a pixel retrieving step of retrieving all pixels each having a color different from that of the adjacent pixel in a specified direction among pixels constituting an image;
a color boundary retrieving step of retrieving all color boundaries each as a group of continuous pixels having the same color among the pixels retrieved in the pixel retrieving step;
a color boundary data generating step of generating color boundary data, for each of the color boundaries retrieved in the lo color boundary retrieving step, including chain code data indicating a position as well as a form of each color boundary and information indicating a color that pixels constituting the color boundary commonly have; and
an output step of outputting data including all the color boundary data generated in the color boundary data generating step as compressed image data concerning the image.

15. An image processing method comprising:
a color boundary diagram generating step of generating, according to compressed image data including a plurality of color boundary data each representing a color boundary with continuous pixels having the same color and comprising chain code data and information indicating colors, a color boundary diagram as an image having a plurality of color boundaries represented by the plurality of color boundary data; and
a decompressed image generating step of generating a decompressed image as an image obtained by allocating, to each of pixels not constituting any color boundary within the color boundary diagram generated by the color boundary diagram generating unit, the same color as that of a pixel positioned in a specified direction to the pixel and constituting the closest color boundary thereto.

16. A computer-readable storage medium containing thereon a program of an image processing method, said program being:
retrieving all pixels each having a color different from that of the adjacent pixel in a specified direction among pixels constituting an image;
retrieving all color boundaries each as a group of continuous pixels having the same color among the pixels retrieved in the pixel retrieving step;
generating color boundary data, for each of the color boundaries retrieved in the color boundary retrieving step, including chain code data indicating a position as well as a form of each color boundary and information indicating a color that pixels constituting the color boundary commonly have; and
outputting data including all the color boundary data generated in the color boundary data generating step as compressed image data concerning the image.

17. A computer-readable storage medium containing thereon a program of an image processing method, said program being:
according to compressed image data including a plurality of color boundary data each representing a color boundary with continuous pixels having the same color and comprising chain code data and information indicating colors generating a color boundary diagram as an image having a plurality of color boundaries represented by the plurality of color boundary data; and
generating a decompressed image as an image obtained by allocating, to each of pixels not constituting any color boundary within the color boundary diagram generated in the color boundary diagram generating unit, the same color as that of a pixel positioned in a specified direction to the pixel and constituting the closest color boundary thereto.
